(19) United States
(12) Patent Application Publication
(10) Pub. No.: US 2004/0170746 A1
(43) Pub. Date: Sep. 2, 2004

(54) Dry and semi-dry sausage product processing and to products therefrom

(76) Inventors: Kyle A. Newkirk, St. Michael, MN (US); James S. Thorson, Scandia, MN (US); Vicky V. Hoel, Blaine, MN (US)

Correspondence Address: GENERAL MILLS, INC., P.O. BOX 1113, MINNEAPOLIS, MN, 55440, US

(21) Appl. No.: 10/375,406

(22) Filed: Feb. 27, 2003

(51) Int. Cl. A23L 1/31

(52) U.S. Cl. 426/646

(57) ABSTRACT

A process for rapidly producing dry or semi-dry sausage product is provided. The process involves the steps of the mixing of ground meat along with an amount of a previously prepared dried sausage, either from the present batch being prepared or from another batch that holds similar qualities to the current batch under preparation. The present process produces dry or semi-dry sausage products in less than 5 hours and preferably less than 3 hours. In addition, the resulting sausage product may be shaped like a conventional pepperoni product as well as a number of unique shapes and configurations not typically associated with conventional sausage products.

### CROSS-REFERENCES TO RELATED APPLICATIONS

None.

### FIELD OF THE INVENTION

The present invention relates in general to the rapid preparation of dry and semi-dry sausage products and, more particularly, to the rapid preparation of dry and semi-dry sausage products through an amount of a previously dried sausage product in an initial meat admixture.

### BACKGROUND OF THE INVENTION

Ingredient costs are typically one of the highest economic components encountered when producing products intended for human or animal consumption. Processes such as aging, drying, curing, etc. slow the availability of such ingredients to the manufacturer as well as increase the overall costs due to the added inventory carrying time and treatment steps that are necessary to produce such a product.

Dry and semi-dry sausage products are classified by the United States Department of Agriculture (“USDA”) according to process conditions, finished product pH, finished product moisture to protein ratio and other factors. For example, in order to meet the criteria for pepperoni, the product must have a finished product moisture to protein ratio of 1.6 to 1 and be processed under conditions specified by the USDA sufficient to kill trichinae. In order to meet the criteria for beef summer sausage, the product must have a finished product moisture to protein ratio of 3.1 to 1 and a finished product pH of no greater than 5.0.

A conventional process for making dry and semi-dry sausage products typically includes the following steps:

Production of most sausages is a very time-consuming process. In a typical process for preparing dry sausage, raw materials such as boneless chucks, beef trimmings, and regular lean pork are chopped and/or ground. The meat (pork, beef and/or poultry) is provided and is then mixed with spices, curing agents and acid-producing bacteria, e.g., lactic acid-producing bacteria. Additional sources of acid such as encapsulated citric acid can also be used. The exact types of meat, spices, curing agents and sources of acid employed depend upon the type of sausage product desired. Dry sausages may or may not be characterized by a bacterial fermentation.

The meat mixture is then formed into the desired shape by stuffing the mixture into casings of prepared animal intestine or synthetic material which are tied shut at both ends to form a single cylindrical unit or at intervals to form lengths. The mixture must be formed into a generally tubular shape before a significant amount of acid is either produced by the bacteria, released by the encapsulating material or otherwise imparted to the admixture. The acid lowers the pH of the mixture to quickly making the meat non-pliable and difficult to shape. The meat is generally easy to work with at a pH of 5.3 or above.

The formed product is then typically allowed to set in a fermenting chamber at a predetermined temperature for a period of time sufficient for enough acid to be produced either by the bacteria, released by the encapsulating material or otherwise imparted to the admixture to lower the pH of the admixture to a value below 5.2, typically below 5.0. The low pH level prevents further bacterial growth and otherwise makes the product biologically stable. The lower pH thus produces an acidic flavor and sets the protein in the meat thereby giving the product a firm texture. The temperature in the fermentation chamber is typically maintained between 60° F. and 105° F. for approximately 7 to 14 hours.

The product is then dried at a predetermined temperature for a period of time that is sufficient to obtain the required finished product moisture to protein ratio (e.g., for pepperoni, 1.6:1). For dry sausage products, the drying step must be carried out under conditions which allow slow controlled uniform removal of moisture from the product while still inhibiting the growth of surface mold or yeast. For example, the drying chamber is typically maintained at a temperature between 50° F. and 70° F. and kept relatively dry to inhibit the growth of mold or yeast. It generally requires several days or even weeks to reach the required finished product moisture to protein ratio depending upon the thickness of the formed product and other process conditions.

Other varieties of sausage include offerings to which a smoky flavor is imparted. This requires the sausage to be smoked prior to being dried but the primary production step still remains a relatively long, continuous air-drying process. Smoking only increases the time necessary to finally produce the product.

Dry sausage usually requires more production time than other types of sausage. Dry sausage generally ranges from about 60% to about 80% of its original weight when sold due to the loss of additional moisture. Semi-dry sausage is usually heated in a large drying oven or smokehouse (where a smoky flavor is desired) to fully cook and partially dry the product.

Unfortunately, maintenance of the required conditions during the extended fermenting and drying steps can make mass production of dry and semi-dry sausage products somewhat difficult. Thus, there is a need for a more economical process for making dry and semi-dry sausage products in a shorter period of time.

The mixture is stuffed into casings and the product is placed in fermentation rooms under controlled conditions to allow growth of the lactic acid producing bacteria. The bacteria causes fermentation of carbohydrates to produce the lactic acid, which gives the sausage, its characteristic flavor. The lactic acid also serves to lower the pH of the meat proteins toward their isoelectric point. This is particularly desirable because the meat proteins are less able to bind moisture as they approach their isoelectric point, thereby facilitating subsequent drying of the sausage.

Once the dry sausage is released from the fermentation room, it is typically placed in a drying room at temperatures in the range of 50° F. to 75° F. and relative humidities of 55 to 85% until the desired ratio of moisture to protein is achieved. In many instances, water in amounts of up to 30 to 40% of the initial weight of the sausage must be removed over a period of several weeks or longer before the predetermined moisture to protein ratio is reached. Although more rapid drying is possible such as by using higher temperatures, which would ordinarily be desirable in order to reduce the processing time, the drying process must be conducted in a uniform and gradual manner in order to ensure a quality product. Rapid drying can cause hardening of the sausage casing, which, in turn, can retard removal of moisture from the interior of the sausage.

Subjecting the sausage to high temperatures during drying or other processing steps may also adversely affect the suitability of the finished product for certain applications. For example, pepperoni slices used as pizza toppings should not cup or curl at the edges during cooking of the pizza because of the tendency for liquid to pool in the cupped slices and the likelihood that the edges will burn or dry out. Use of high temperatures during processing of the pepperoni is one factor, which has been determined to contribute to cupping of the pepperoni slices.

In addition to the extended time periods required to properly dry sausages, USDA regulations require that dry and semi-dry sausage which are not cooked during processing be heat treated by holding the sausage for predetermined time periods at preselected temperatures. These times and temperatures are selected to ensure destruction of microorganisms such as trichinae which may be present in the meat and can lead to serious illness or death in humans. The time period required for drying is shortened by the use of higher temperatures and can be instantaneous when the product's internal temperature reaches approximately 145° F. The use of these high temperatures during processing, however, can be detrimental to the performance of the final product when used for certain purposes such as pizza toppings. As a result, a need has developed for a sausage, which can be processed at elevated temperatures without adversely affecting the performance of the resulting product.

U.S. Pat. No. 6,004,592 to Holdren et al. teaches a dry or semi-dry sausage product that includes up to 15% by weight of an added particulate protein component, such as denatured or hydrolysed protein. The denatured or hydrolysed protein can include meat stock, milk protein hydrolyzate, yeast extract, vegetable protein, animal protein and cooked meat. It is preferred that the added protein component does not bind water and is non-gelling and non-coagulating. The added protein is in addition to the protein present in the meat used in the sausage mixture and serves to improve the performance of the product, particularly after the sausage has been heated to internal temperatures as high as 145° F. during processing to eliminate pathogens.

The dry and semi-dry sausages of the Holdren invention are typically prepared by grinding or chopping to one-half inch in diameter, and then mixing the other ingredients, including the added protein component, with the ground or chopped meat. A starter culture of lactic acid bacteria is diluted prior to mixing with the chopped meat. The mixture is then subjected to a finish grinding step in which the meat is further reduced to the desired size for the particular product. The mixture is then stuffed into casings and held in a green room for a period of time at appropriate conditions to cause fermentation. Once the pH of the stuffed sausage reaches a pre-selected value, it is subjected to heating to raise the internal temperature of the sausage up to as high at 160° F. for a brief period of time to kill trichinae. Dry sausage is then placed in a drying room and held at temperatures and relative humidities to provide uniform drying of the sausage until the desired moisture to protein ratio is achieved. The product is then removed from the drying room and can be further processed as desired. It will of course be appreciated that the process can be varied as required for particular sausage recipes.

However, the Holdren process does not teach the use of a previously dried sausage product as an additive to the initial meat admixture. It will be appreciated that a dried sausage product additive, not only includes a degree of protein, but will also include an amount of water, fats and optionally seasonings and spices.

Surprisingly, the inventors of the present invention have found that the use of a dried sausage product in the initial meat admixture contributes to considerable product drying efficiencies and enables the use of high product drying temperatures, while still retaining the integrity, texture and flavor of the final products. The process allows dry and semi-dry sausage products to be mass-produced in a matter of 2 to 3 hours as opposed to days or weeks. The inventive process is particularly useful for producing pepperoni pieces suitably shaped and dimensioned for snack size or ready-to eat pieces or pizza toppings.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The process of the invention utilizes an amount of a dried sausage product in the initial meat admixture to form and cook a mixture of meat and ingredients into dry or semidry sausage products. The traditional fermentation step used in making pepperoni and the like is replaced by an acidulation step to minimize the time required in preparing the product. These resulting products are then further dried to meet the United States Department of Agriculture (USDA) requirements. The process further includes the step of forming the dried or semi-dried sausage admixture into shaped pieces such as pepperoni pieces that are suitable for use on pizza toppings.

It is thus a primary object of this invention to provide a method for producing a savory sausage product in a significantly reduced amount of processing time. The processes is intended to be used for meat products suitable for use as traditional pepperoni. The reduced time frame significantly decreases the processing costs and enables increased throughput. The resulting extruded semi-dry or dry extruded product can be formed into several shapes suitable for use as pizza or food toppings or snack packs. The shapes may be cut in two or three dimensional form from a sheet of suitably extruded dry and semi-dry sausage product.

To accomplish these and other related objects of the invention, in one aspect the present invention there is provided a process for rapidly producing at least one dry or semi-dry sausage product comprising the steps of admixing an amount of ground meat with an amount of dried sausage product and edible acidulant to form a sausage admixture. The sausage admixture is then formed into at least one shaped sausage product. The shaped sausage product is subsequently dried to achieve a desired water to protein ratio.

Preferably, the process is operated on a continuous basis and an extruder is employed to form the sausage product into a desired shape.

The process may further include the step of dividing the dried sausage product that is obtained from the drying step into at least first and second product streams, so that optionally a portion of the sausage product from one of the first and second product streams in an amount of dried sausage product up to about 50% by weight of the combined weight of dried sausage product in the first and second product streams is then fed back into the initial step of the process cycle described above.

In the exemplary embodiments described herein, the amount of dried sausage product to be added to the ground meat ranges from between about 10-50% by weight of the total weight of the ground meat, more preferably, the amount of dried sausage product to be added to the ground meat comprises between about 25-45% by weight of the total weight of the ground meat.

The size and shape of the formed sausage product has at least one cross-sectional dimension between about ⅙^{th} inch to about 1 inch and more preferably between about 1/16^{th} inch to about ½ inch.

Additionally, the method may further include the step of cutting or dicing the extruded sausage mixture into desired two dimensional or three dimensional shapes such as star shapes, snake shapes, round shapes, character shapes, other more ornate configurations than conventionally shaped products and the like.

In the exemplary embodiment described herein, the drying step takes between about 5 minutes to 2 hours, more preferably, between about 10 minutes to 45 minutes. The drying step is conducted at a temperature of between about 140° F. to about 280° F., more preferably at a temperature of between about 160° F. to about 250° F. so as to achieve effective drying of the sausage product, in order to achieve the desired water to protein ratio of the sausage product. In a preferred embodiment, water to protein ratio of the sausage product is about 1.6:1 by weight.

In the present exemplary emboidment, the ground meat is selected from pork, beef and poultry, or mixtures thereof. Other combinations are of course possible, including alligator, bison, bear, elk, deer, ostrich, game birds and other fowl, etc. The grade of meat that is used in this process may optionally be less than that of traditional semi-dry or dry sausage products without sacrificing flavor.

The edible acidulant is selected from glucano-δ-lactone, lactic, malic, citric, acetic, isoascorbic, adipic, tartaric, sorbic acid and mixtures thereof. It is also preferred that the amount of ground meat to the amount of acidulant ratio is between 99:1 to 95:5 by weight, more preferably the amount of ground meat to the amount of acidulant ratio is between 97:3 by weight.

The process may preferably further include the step of admixing one or more spices and/or one or more seasonings into the ground meat, dried pepperoni acidulant admixture, wherein the spices are selected from red pepper, black pepper, white pepper, anise, fennel, and others and the seasonings are selected from liquid oleoresins of spices, ground mustard, salt, garlic, onion and others. Preferably, the dried sausage product is pepperoni.

It is also preferred that the process further includes the step of freezing the resulting sausage product as required for shipping or storage.

In another aspect, the invention is related to a semi-dry or dry sausage product prepared according to the method described above.

Preferably, the semi-dry or dry sausage product is selected from beef summer sausage, thuringer, sicillian salami, pepperoni, dry salami or genoa, and is shaped and dimensioned into snack size or ready-to-eat pieces, or can be formed into shapes suitable for use in pizza or food toppings. In one exemplary embodiment, the dry sausage product is pepperoni.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a high-level flow diagram that setting forth exemplary steps as part of a preferred embodiment of the present invention; and

FIG. 2 depicts a variety of shapes in which the product produced by the current process may be provided.

### DETAILED DESCRIPTION OF THE INVENTION

The present invention is now illustrated in greater detail by way of the following detailed description, but it should be understood that the present invention is not to be construed as being limited thereto.

In accordance with the inventive process, meat, such as pork, poultry and beef is first admixed with an acidulant to form a sausage admixture. The type of meat used depends upon the type of dry or semi-dry sausage product desired. Examples of meats that can be used include fresh and frozen pork, beef, and/or poultry. Certain other red meats as well can also be included in association with particular products. Other combinations are of course possible, including alligator, bison, bear, elk, deer, ostrich, game birds and other fowl, etc. and combinations thereof.

The amount of fat present in the meat is also a factor. The amount of fat needed varies depending upon the type of product, flavor and the like that is desired. For example, for pepperoni, meat consisting of at least about 90% by weight based on the total weight of the meat of finally divided raw meat selected from pork, beef, poultry and mixtures thereof, and having a total meat fat content no greater than about 58% by weight based on the total weight of the meat is very suitable.

In accordance with the present invention, a portion of the previously dried sausage product is initially reground or reintroduced into the process by either admixing it with an additional amount of the fresh ground meat and acidulant admixture or can be added to the ground meat prior to the addition of the acidulant. Preferably, the source of the dried sausage is from the product stream of a previous batch of product produced by the process of the present invention. However, it is to be appreciated that an amount of a dried or semi-dried sausage product could be obtained externally of the process and reground and then added to the ground meat/acidulant admixture. This would be the case in the initial development of the process where a previous product batch was not immediately or otherwise available.

Alternatively, situations can be envisaged whereby the actual nature of the desired dried or semi-dried sausage varies considerably from a previous batch of product and is not suitable for use in subsequent batches because of its flavor or texture properties and the like. The amount of dried or semi-dried sausage product added to the ground meat can amount up to 50% by weight of the total weight of the ground meat. It is preferred that the amount of dried sausage product added to the ground meat comprises between about 10-50%.

In the exemplary embodiment where the dried or semi-dried sausage product comes from a product stream from a previous batch of dried or semi-dried sausage product obtained by the process of the present invention, as much as 50% of the product stream by weight can be used to feed back into the subsequent batch of ground meat. The actual amount of the product stream that is fed back into subsequent batches depends on the overall characteristics of the desired dried or semi-dried sausage product. It would be clear to an artisan how to select the amount required depending on the desired characteristics of the end product.

As used herein and in the appended claims, the term “acidulant” denotes any food grade acid as well as compounds, which react with water to generate food grade acids such as glucono-δ-lactone. A food grade acid is an acid, which is suitable for human consumption, United States purity grade and approved by the USDA. Examples of food grade acids that can be used include citric acid, lactic acid, acetic acid, sorbic acid, tartaric acid, isoascorbic acid, adipic acid and mixtures thereof. The acidulant used in connection with the present invention is preferably selected from the group consisting of glucano-δ-lactone, lactic, malic, citric, acetic, isoascorbic, adipic, tartaric, sorbic acid and mixtures thereof. The acidulant. and the preferred ratio of ground meat to the amount of acidulant is between 99:1 to 95:5 by weight.

The acidulant must be used in an amount and have a strength sufficient to lower the pH of the sausage admixture to a value no greater than 5.3 in the resulting meat product. Preferably, the acidulant is used in an amount and has a strength sufficient to lower the pH of the sausage admixture to a value between 5.0 and 4.1. The exact pH will vary depending in part on the type of sausage product, flavor desired, and the like. For example, for pepperoni, the acidulant is preferably employed in an amount and has a strength sufficient to lower the pH of the sausage admixture to a value of 4.3. Such a low pH enhances the flavor of pepperoni.

The exact amount of the acidulant required depends in part on the initial pH of the meat, the desired pH of the meat, the buffering capacity of the meat, the type and amount of additives admixed with the meat and the strength of the specific acidulant used. Generally, the amount of acidulant that must be employed is in the range of from about 1% by weight to about 5% by weight based on the weight of the meat.

Spices, seasonings and curing agents may also be optionally employed in the sausage admixture. These ingredients are preferably admixed with the ground meat at around the time the acidulant is admixed with the meat. The particular spice(s) and/or curing agent(s) employed depend on the end product desired. Examples of spices that can be used include white pepper, anise, fennel, red pepper, oregano, black pepper and mixtures thereof. Examples of curing agents that can be used include sodium nitrite, sodium erythorbate, potassium nitrite, potassium nitrate, sodium nitrate and mixtures thereof. If spices are used, they are generally employed in a total amount of from about 1% to about 6% by weight based on the weight of the meat. The amount of the curing agents used varies depending on the particular agent(s). For example, sodium nitrite and potassium nitrite are each used in an amount of about 0.25 ounces per 100 pounds of meat. Sodium nitrate and potassium nitrate are each used in an amount of about 2.75 ounces per 100 pounds of meat. The curing agents function to retain the red meat color and kill trichinae.

Additional ingredients including binders and extenders can be admixed with the meat as known to those skilled in the art of sausage making. Such additional ingredients are preferably added to the sausage admixture at around the same time as the acidulant, spices, curing agents and/or protein source are admixed with the meat but may also be added in a sequential fashion.

It will be appreciated that the dried or semi-dried sausage product, acidulant, spice(s), curing agent(s), and any other ingredients employed can be admixed with the meat by any method that uniformly distributes the ingredients throughout the meat. In the present, invention, a conventional meat blender can be employed.

Generally, about 2 to about 5 minutes of mixing time is sufficient. The meat is preferably chopped, ground or otherwise finely divided, most preferably ground, prior to admixing the acidulant and other ingredients therewith.

Once the meat is admixed with the dried or semi-dried sausage product and/or acidulant and any other ingredients employed to form a sausage admixture, the sausage admixture is preferably shaped and formed into at least one shaped sausage product, preferably a plurality of shaped sausage products. Such shapes may include any of animate, themes, characters, stars, squares, rectangles, hexagonals, pentagonals or combinations thererof.

The shaped products can be formed through an extrusion step or can be manually shaped depending on the properties of the desired product. Preferably, each shaped sausage product formed must have a thickness and overall shape that allows sufficient heat exchange and moisture transfer in the subsequent drying step. It has been found that sufficient heat exchange and moisture transfer in the drying step can be achieved if each sausage product formed has at least one cross-sectional dimension (e.g., length, width, height, and diameter) no greater than about 2 inches. Each shaped sausage product formed preferably has at least one cross-sectional dimension no greater than about 1 inch, more preferably at least one cross-sectional dimension in the range of from about 1/16^{th} inch to about ½ inch.

In one embodiment, the sausage admixture is formed into a plurality of sausage products, in either sheets or strips each having at least one cross-sectional dimension no greater than about 1 inch, and more preferably no greater than about ½ inch.

The process inventive process may be utilized to produce novel shaped pieces for dry or semi dry sausage, such as pepperoni pieces that are snack sized, or pepperoni pieces that are suitable for use on pizza or other food toppings.

An extrusion device that may be employed for the invention can be achieved using a simple extruder such as a VeMag-type stuffer. The invention can utilize a single or twin-screw extruder.

In general, the smaller the dimensions of the shaped sausage product(s) formed the greater the rate of heat penetration and moisture removal achieved in the drying step. The nature of the extrusion process allows nuggets and other sausage products having non-conventional shapes to be formed.

Once the sausage admixture is formed into one or more shaped sausage products, the product(s) are heated and then dried until the desired moisture to protein ratio in the product is achieved. Typically, the drying time is between about 5 minutes to about 2 hours, and more preferably from about 10 minutes to about 45 minutes. The drying temperature is conducted at a temperature of between about 140° F. to about 280° F. It is preferred that the drying temperature is between 160° F. to about 250° F.

For sausage that contains pork, it is important to heat the product(s) at a temperature and for a period of time that is also sufficient to ensure that trichinae and any harmful bacteria is destroyed in accordance with U.S.D.A. regulations. For example, for pepperoni, it is necessary to heat the product(s) at a temperature and for a period of time sufficient to raise the internal temperature of the product(s) to at least about 150° F., and more preferably to at least about 170° F. Trichinae is destroyed in accordance with the inventive process by the curing and heating aspects of the process described above. U.S.D.A. prescribed treatments ,of pork and products containing pork are set forth in Code of Federal Regulations, Section 318.10 (May, 1985), which is incorporated by reference herein.

It will be appreciated that the length of time of the heating/drying step will vary depending on many process parameters and factors including the type of product(s) being produced and the particular requirements therefor, including the initial amount of moisture in the product(s), the shape of the product(s) being heated, the temperature being used and the type of heating apparatus being used.

The required finished product moisture to product ratio for various types of dry and semi-dry sausage products is shown below in the following table.

| Product | Moisture to Protein Ratio |
|---|---|
| Beef summer sausage | 3.1:1 |
| Pepperoni | 1.6:1 |
| Jerky | 0.75:1 |
| Dry sausage | 1.9:1 |
| Thuringer | 3.7:1 |
| Dry salami | 1.9:1 |
| Genoa salami | 2.3:1 |
| Farmer summer sausage | 1.9:1 |

The drying step can be carried out using many different types of heating devices, including but not limited to linear forced air dryers/oven, vacuum dryers, spiral forced air dryers, batch ovens and the like.

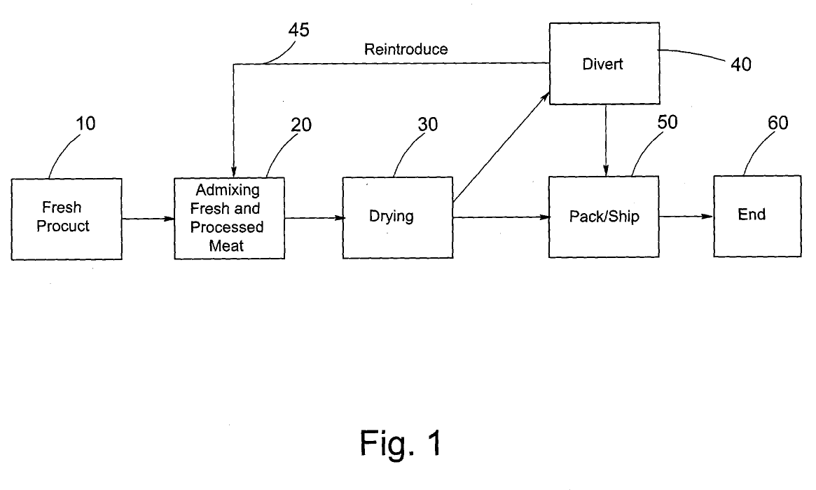

Once the drying step has been completed, the product stream can be split into at least first and second product streams. The first product stream that is separated from the dried products can be fed back into a further cycle of the process of the present invention. That is, the first product stream can be ground and then combined with the ground meat that is destined for use in a further cycle of the invention. This product stream feedback loop is illustrated in FIG. 1.

The second stream represents those products that are destined for the consumer market. The second product stream being the dried and suitably shaped products can then be packaged, chilled, optionally frozen and shipped/stored as required.

In a preferred embodiment, the inventive process as illustrated in FIG. 1 is employed on a continuous basis to mass-produce dry or semi-dry sausage products.

As illustrated in FIG. 1, fresh product, meat preferably pork, beef and combinations thereof are provided initially at step 10. The fresh product is ground as outlined above in an ordinary food grinder or blender and is then mixed with a portion of previously processed meat or “starter” processed meat from a previously prepared batch along with acidulant and any seasonings that are necessary at step 20. After the material is mixed it is extruded, heated and dried at step 30. From the drying step 30, the material is divided into at least first and second streams. At least one stream enters the pack/ship step where it is prepared for retail distribution at step 50 while at least the second stream is diverted at step 40. The divert step 40 sends a portion of the second stream on to the pack/ship step 50 and also sends a portion of the stream to be reintroduced at step 45 into the admixing step 20. From the pack/ship arrangement, the process ends at step 60.

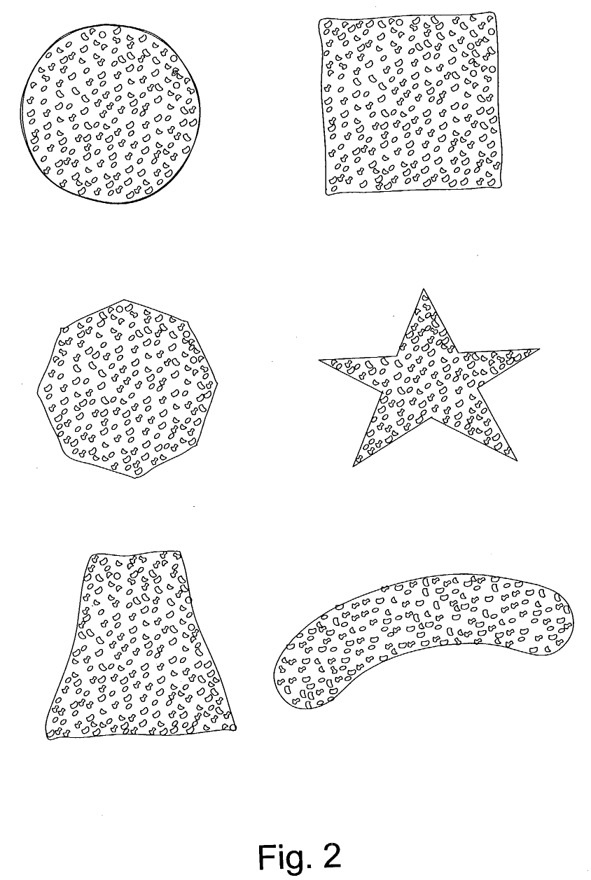

Turning briefly to FIG. 2, the illustration depicts a number of configurations and shapes that may be produced in connection with the present embodiment. Other configurations, shapes, designs, etc. are of course possible.

In order to further illustrate the inventive process, the following example is given. Although the example is presented to illustrate certain specific embodiments of the invention, it is not to be construed as restricting the scope and spirit of the invention.

### EXAMPLE I

A sample of dry sausage (pepperoni) was produced in accordance with the inventive process. First, the meat, approximately 5 kg, was ground and then admixed with an amount ranging from about 0.5 to about 3 kg of a dried sausage product and then further admixed with an acidulant to form a sausage admixture. The meat consisted of a mix approximately 30% beef and 70% pork. The meat was ground together in a conventional meat grinder prior to being admixed with the other ingredients. The total fat content in the meat was about 35% by weight based on the weight of the meat (meat referring to the meat mix).

The acidulant is a combination of citric and lactic acid and was used in an amount by weight relative to the meat of approximately 1.5% each.

The spices and seasonings used were conventional sausage or Italian seasonings obtained from Chris Hanson Corp. and included approximately 5% by weight of the batch prepared.

The ground meat mix was admixed with the acidulant, spices, seasonings, curing agent in a conventional meat blender for approximately 4 minutes.

Next, the sausage admixture was continuously extruded into a plurality of rectangular strips, each strip being approximately 4 inches wide and ⅜ of an inch high. The strips were extruded by loading the sausage admixture into an extrusion chamber and using a piston to push the admixture through an extrusion head.

The resulting extruded sausage product was then cut into shapes or pieces having the following dimensions one and half inches (½″) by one and half inches (½″).

The heating device through which the pepperoni pieces were dried was a batch oven operating at a temperature of approximately 150° F. and the time required for drying was approximately 30 minutes.

A few of the pieces were analyzed upon exiting the oven. The pieces looked and tasted like conventional pepperoni, had a pH level of around 4.3 and a moisture to protein ratio of 1.6:1 or less.

Thus, the present invention is well adapted to carry out the objects and attain the ends and advantages mentioned as well as those which are inherent therein. The preceding examples can be repeated with similar success by substituting the generically or specifically described components and/or operating conditions of this invention for those used in the examples.

Furthermore, although certain preferred embodiments of the invention have been described for illustrative purposes, it will be appreciated that various modifications and innovations of the process recited herein may be effected without departure from the basic principals which underlie the invention. Changes of this type are therefore deemed to lie within the spirit and scope of the invention except as may be necessarily limited by the appended claims and reasonable equivalents thereof.

It will thus be seen according to the present invention a highly advantageous process for producing dry and semi-dry sausage products has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A process for rapidly producing at dry or semi-dry sausage product comprising the steps of
i) admixing an amount of ground meat and an amount of dried sausage product with an amount of an edible acidulant to form a sausage admixture;
ii) forming the sausage admixture into at least one shaped sausage product; and
iii) drying the shaped sausage product to achieve a desired water to protein ratio.

2. The process according to claim 1, wherein the process is continuous.

3. The process according to claim 1, wherein an extruding device is employed to form the sausage product into a desired shape.

4. The process according to claim 1, further including a step of dividing the dried sausage product from step iii) into at least first and second product streams.

5. The process according to claim 4, wherein the amount of dried sausage product in the second product stream is fed back into step i) of a further process cycle of the process as defined in claim 1.

6. The process according to claim 4, wherein the amount of dried sausage product in the second product stream amounts to up to 50% by weight of the combined weight of dried sausage product in the at least first and second product streams.

7. The process according to claim 1 wherein the amount of dried sausage product added to the ground meat comprises between about 10-50% by weight of the ground meat.

8. The process according to claim 1, wherein the amount of dried sausage product added to the ground meat comprises between about 25 to about 45% by weight of the total weight of the ground meat.

9. The process according to claim 1, wherein the size and shape of the sausage product has at least one cross-sectional dimension between about 1/16^{th} inch to about 1 inch.

10. The process according to claim 1, wherein the size and shape of the sausage product has at least one cross-sectional dimension between about 1/16^{th} inch to about ½ inch.

11. The process according to claim 1, wherein the method further includes the step of cutting or dicing the extruded sausage mixture into desired shapes.

12. The process according to claim 1, wherein the desired shapes include star, snakes, round, animate, themes, characters, squares, rectangles, hexagonals, pentagonals or combinations thererof.

13. The process according to claim 1, wherein the drying step takes between about 5 minutes to about 2 hours.

14. The process according to claim 1, wherein the drying step is conducted at a temperature of between about 140° F. to about 280° F. so as to achieve effective drying of the sausage product.

15. The process according to claim 1, wherein the desired water to protein ratio of the sausage product is about 1.6:1 by weight.

16. The process according to claim 1, wherein the ground meat is selected from pork, beef and poultry or mixtures thereof.

17. The process according to claim 1, wherein the edible acidulant is selected from glucano-δ-lactone, lactic, malic, citric, acetic, isoascorbic, adipic, tartaric, or sorbic acids and mixtures thereof.

18. The process according to claim 1, wherein the ground meat to the amount of acidulant is provided in a ratio between 99:1 to 95:5 by weight.

19. The process according to claim 1, wherein the process further includes the step of admixing one or more spices and/or one or more seasonings into the ground meat, dried sausage and acidulant admixture.

20. The process according to claim 19, wherein the spices are selected from red pepper, black pepper, white pepper, anise, fennel, and others.

21. The process according to claim 19, wherein the seasonings are selected from liquid oleoresins of spices, ground mustard, salt, garlic, onion and others.

22. The process according to claim 1, wherein the dried sausage product is pepperoni.

23 A dry or semi-dry sausage product obtained according to the process of claim 1.

24. The dry or semi-dry sausage product according to claim 23, wherein the sausage product is selected from beef summer sausage, thuringer, sicillian salami, pepperoni, dry salami or genoa.

25. The dry sausage product according to claim 23, wherein the dry or semi-dry sausage product is pepperoni.

26. The dry or semi-dry sausage product according to claim 23, wherein the product is shaped and dimensioned into snack size or ready-to-eat pieces or combinations thereof.

27. The dry or semi-dry sausage product according to claim 23, wherein the product is shaped and dimensioned into pieces suitable for use as pizza or food toppings.
